(19) United States
(12) Patent Application Publication
(10) Pub. No.: US 2025/0018655 A1
(43) Pub. Date: Jan. 16, 2025

(54) INDEPENDENT MODE ON INDEPENDENT DUAL HEAD PRINTER

(71) Applicant: NEXA3D, INC., Ventura, CA (US)

(72) Inventors: Jorge Arturo MIJARES TOBIAS, Puebla (MX); Chad EICHELE, Lake Forest, CA (US); Luke JOHNSON, Austin, TX (US); Matthew SKOLAUT, Houston, TX (US); Bryan ZAHNER, College Station, TX (US)

(21) Appl. No.: 18/716,094

(22) PCT Filed: Dec. 21, 2022
(86) PCT No.: PCT/US2022/082112

§ 371 Date: Jun. 3, 2024

Related U.S. Application Data
(60) Provisional application No. 63/292,939, filed on Dec. 22, 2021.

(51) Int. Cl. B29C 64/386; B29C 64/118; B29C 64/182; B29C 64/209; B29C 64/35; B33Y 10/00; B33Y 30/00; B33Y 50/00; G05B 19/4099

(52) U.S. Cl. CPC B29C 64/386; B29C 64/118; B29C 64/182; B29C 64/209; B29C 64/35; B33Y 10/00; B33Y 30/00; B33Y 50/00; G05B 19/4099; G05B 2219/35012; G05B 2219/36019

(57) ABSTRACT

A method, a system, and a printer for printing at least two independent objects. A first CAD file and a second CAD file is provided to a slicer, wherein the first CAD file represents a first object and the second CAD file represents a second object. The first CAD file is into a first set of instructions for printing the first object and a second set of instructions for printing a second object. A first build area for the first object and a second build area for the second object are defined and the first build area is spaced from the second build area a distance in an X, Y-plane. A g-code file is created including the first set of instructions for printing the first object and the second set of instructions for printing the second object. The printer parses and executes the g-code file.

### RELATED APPLICATIONS

This application is a National Stage under 35 USC 371 of and claims priority to International Application No. PCT/US2022/082112, filed 21 Dec. 2022, which claims the priority benefit of U.S. Provisional Application No. 63/292,939, filed 22 Dec. 2021.

### INTRODUCTION

Three-dimensional printers deposit material on a print surface in successive layers to form three-dimensional components. One or more print heads may be provided in a single three-dimensional printer. When more than one print head is present, there are a number of ways that the print heads may be controlled. For example, the print heads may each print a copy of a given object at the same time. In various aspects, while in this mode, both print heads follow the same instructions and a similar print path, but the print head paths are set apart from each other and the print paths do not intersect. Another method of printing allows the print heads to print the same component using mirrored print paths. Again, the print heads are set apart from one and the print head paths do not intersect. However, in independent printing where the print heads may print different components at the same time it is necessary to prevent the path of the print heads from intersecting, which may result in damage to the print heads and other components of the printer. It is therefore desirable to further develop methods and systems for enabling independent printing.

### SUMMARY

The present disclosure is directed to implementing independent mode, allowing the printer to print with independent motion in the X-Y direction for each of its print heads while sharing a print bed, to print different objects at the same time.

According to various aspects, the present disclosure is directed to a method of printing at least two independent objects. The method includes providing a first CAD file and a second CAD file to a slicer, wherein the first CAD file represents a first object and the second CAD file represents a second object, and slicing the first CAD file into a first set of instructions for printing the first object and slicing the second CAD file into a second set of instructions for printing a second object. The method further includes defining a first build area for the first object and defining a second build area for the second object, and spacing apart the first build area from the second build area a distance in an X, Y-plane. The method yet further includes creating a g-code file including the first set of instructions for printing the first object and the second set of instructions for printing the second object, wherein the second object is spaced apart the distance in the X, Y-plane from the first object in the g-code file. The method further includes executing the g-code file by a printer, and printing the first object with a first print head on a print bed in the printer and the second object with a second print head on the print bed in the printer, wherein at least of a portion of the first object and the second object are printed simultaneously and the first object is spaced apart from the second object the distance in the X, Y-plane.

In embodiments of the above, slicing the first CAD file and the second CAD file includes parsing the first CAD file in a first plurality of layers and the second CAD file into a second plurality of layers and creating a first print path for the first plurality of layers and a second print path for the second plurality of layers. In further embodiments, the first set of instructions and the second set of instructions are set as sequential print jobs in the g-code file. In yet further embodiments, the printer includes an on-board machine parser and executing the g-code file includes checking if the g-code file includes m-code indicating the g-code file includes the first set of instructions and the second set of instructions for simultaneously printing the first object and the second object. In additional embodiments, the method further includes splitting the first set of instructions for the first object from the second set of instructions for the second object while executing the g-code.

In any of the above embodiments, the method further includes determining which of the first object and the second object is taller and setting one of the first print head and the second print head as a bed owner based on which of the first object and the second object is taller. In further embodiments, the method includes lowering the print bed based one of the first set of instructions and the second set of instructions that is associated with the bed owner.

In any of the above embodiments, the first set of instructions include a motion in a z-axis after printing at least one layer of a first plurality of layers and the second set of instructions include a motion in the z-axis after printing at least one layer of a second plurality of layers. In addition, the method further includes replacing the motions with a synchronization sequence. In further embodiments, the synchronization sequence includes wiping and parking one of the first print head and the second print head that finishes printing a given layer of both the first plurality of layers the second plurality of layers first. In yet further embodiments, the synchronization sequence further includes setting a first flag when the first print head is finished printing the given layer and setting a second flag when the second print head is finished printing the given layer; resetting the first flag and the second flag after both the first flag and the second flag are set; checking both the first flag and the second flag have been reset; and executing a lower print bed command for the one of the first print head and the second print head set as a bed owner. In additional embodiments, the method further includes running an auto-response routine for the print head that finishes printing first of the first print head and the second print head.

In any of the above embodiments, the method includes setting the distance sufficient to prevent the first print head and the second print head from colliding while the first print head prints the first object and the second print head prints the second object.

In any of the above embodiments, the method further includes generating the first CAD file and generating the second CAD file.

According to various additional aspects, the present disclosure is directed to a printer for printing at least two independent objects. The printer includes a controller. Connected to the controller are a print bed, a first print head for printing a first object on the print bed, a second print head for printing a second object on the print bed, and an onboard machine parser. The controller is configured to execute instructions to parse a g-code file including a first set of instructions for printing a first object and a second set of instructions for printing a second object, and print the first object with the first print head and print the second object with the second print head on the print bed in the printer, wherein at least of a portion of the first object and the second object are printed simultaneously and the first object is spaced apart from the second object a distance in an X, Y-plane.

According to embodiments of the above, the controller is further configured to execute instructions to check if the g-code file includes m-code indicating the g-code file includes the first set of instructions and the second set of instructions for simultaneously printing the first object and the second object.

According to any of the above embodiments, the controller is further configured execute instructions to split the first set of instructions for the first object from the second set of instructions for the second object while executing the g-code.

According to any of the above embodiments, the controller is further configured to execute instructions to determine which of the first object and the second object is taller and setting one of the first print head and the second print head as a bed owner based on which of the first object and the second object is taller. Further, in embodiments, the controller is configured to execute instructions to lower the print bed in a z-axis based one of the first set of instructions and the second set of instructions that is associated with the bed owner. In yet further embodiments, the first set of instructions include a first motion in a z-axis after printing at least one layer of a first plurality of layers and the second set of instructions include a second motion in the z-axis after printing at least one layer of a second plurality of layers and wherein the controller is further configured to execute instructions to replace the first motion and the second motion in the z-axis with a synchronization sequence. In yet further embodiments, during the synchronization sequence the controller if further configured to execute instructions to wipe and park one of the first print head and the second print head that finishes printing a given layer of both the first plurality of layers the second plurality of layers first. In yet further embodiments, the synchronization sequence further includes setting a first flag when the first print head is finished printing the given layer and setting a second flag when the second print head is finished printing the given layer; resetting the first flag and the second flag after both the first flag and the second flag are set; checking both the first flag and the second flag have been reset; and executing a lower print bed command for the one of the first print head and the second print head set as a bed owner. In yet further embodiments, the controller is further configured to run an auto-response routine for the print head that finishes printing first of the first print head and the second print head.

According to any of the above embodiments, the controller is further configured to execute instructions to set the distance sufficient to prevent the first print head and the second print head from colliding while the first print head prints the first object and the second print head prints the second object.

According to various additional aspects, the present disclosure is directed to a system for printing at least two independent objects. The system includes a controller and an on-board machine parser connected to the controller, wherein the controller is configured to execute instructions to parse a g-code file including a first set of instructions for printing a first object and a second set of instructions for printing a second object, and print the first object with a first print head and print the second object with a second print head, wherein at least of a portion of the first object and the second object are printed simultaneously and the first object is spaced apart from the second object a distance in an X, Y-plane.

According to embodiments of the above, the first set of instructions and the second set of instructions are set as sequential print jobs in the g-code file.

According to any of the above embodiments, the g-code file includes m-code indicating the g-code includes the first set of instructions and the second set of instructions for simultaneously printing the first object and the second object.

According to any of the above embodiments, the controller is further configured to execute instructions to split the first set of instructions for the first object from the second set of instructions for the second object while executing the g-code.

According to any of the above embodiments, the controller is further configured to execute instructions to determine which of the first object and the second object is taller; and set one of the first print head and the second print head as a bed owner based on which of the first object and the second object is taller. In further embodiments, the controller is further configured to execute instructions to lower a print bed based one of the first set of instructions and the second set of instructions that is associated with the bed owner.

According to any of the above embodiments, the first set of instructions include a motion in a z-axis after printing at least one layer of a first plurality of layers and the second set of instructions include a motion in the z-axis after printing at least one layer of a second plurality of layers and the controller is further configured to execute instructions to replace the motions with a synchronization sequence. In further embodiments, the controller is further configured to execute instructions to wipe and park one of the first print head and the second print head that finishes printing a given layer of both the first plurality of layers the second plurality of layers first. In yet further embodiments, the controller is further configured to execute instructions to set a first flag when the first print head is finished printing the given layer and set a second flag when the second print head is finished printing the given layer; reset the first flag and the second flag after both the first flag and the second flag are set; check both the first flag and the second flag have been reset, and execute a lower print bed command for the one of the first print head and the second print head set as a bed owner. In yet further embodiments, the controller is configured to execute instructions to run an auto-response routine for one of the print head and the second print head that finishes printing first.

According to several embodiments, the present disclosure is directed to a method of creating a g-code file for at least two independent objects. The method includes providing a first CAD file and a second CAD file to a slicer, wherein the first CAD file represents a first object and the second CAD file represents a second object and slicing the first CAD file into a first set of instructions for printing the first object and a second set of instructions for printing a second object. The method further includes defining a first build area for the first object and a second build area for the second object for any given layer of both the first object and the second object and spacing apart the first build area from the second build area a distance in an X, Y-plane. The method also includes creating a g-code file including the first set of instructions for printing the first object and the second set of instructions for printing the second object, wherein the second object is spaced apart the distance in the X, Y-plane from the first object in the g-code file.

In embodiments of the above, slicing the first CAD file and the second CAD file includes parsing the first CAD file in a first plurality of layers and the second CAD file into a second plurality of layers and creating a first print path for the first plurality of layers and a second print path for the second plurality of layers.

In any of the above embodiments, the first set of instructions and the second set of instructions are set as sequential print jobs in the g-code file.

In any of the above embodiments, the method further includes setting the distance in the X, Y-plane sufficient to prevent a first print head and a second print head from colliding while the first print head prints the first object and the second print head prints the second object.

In any of the above embodiments, the method further includes generating the first CAD file and generating the second CAD file.

According to various aspects, the present disclosure is also directed to a system for creating a g-code file for printing at least two independent objects simultaneously. The system includes a controller configured to execute instructions to slice a first CAD file representing a first object to provide a first set of instructions for printing the first object and a second CAD file representing a second object to provide a second set of instructions for printing the second object. The controller is further configured to execute instructions to define a first build area for the first object and defining a second build area for the second object, and space apart the first build area from the second build area a distance in an X, Y-plane. The controller is also configured to create a g-code file including the first set of instructions for printing the first object and the second set of instructions for printing the second object, wherein the second object is spaced apart the distance in the X, Y-plane from the first object in the g-code file.

In embodiments of the above, the controller is further configured to execute instructions to parse the first CAD file in a first plurality of layers and the second CAD file into a second plurality of layers and create a first print path for the first plurality of layers and a second print path for the second plurality of layers while slicing.

In any of the above embodiments, the controller is further configured to execute instructions to set the first set of instructions and the second set of instructions as sequential print jobs in the g-code file.

In any of the above embodiments, the controller is further configured to execute instructions to set the distance in the X, Y-plane a sufficient distance to prevent a first print head and a second print head from colliding while the first print head prints the first object and the second print head prints the second object.

In any of the above embodiments, the controller is further configured to execute instructions to generate the first CAD file and generating the second CAD file.

### BRIEF DESCRIPTION OF THE DRAWINGS

The drawings described herein are for illustration purposes only and are not intended to limit the scope of the present disclosure in any way.

FIG. 1 illustrates an embodiment of a three-dimensional printer including two print heads, according to an embodiment of the present disclosure;

FIG. 2 illustrates an embodiment of a print head including a nozzle, according to an embodiment of the present disclosure;

FIG. 3 illustrates an embodiment of a wiper located within the interior of a three-dimensional printer, according to an embodiment of the present disclosure;

FIG. 4 illustrates an embodiment of a method of printing multiple independent objects with a three-dimensional printer, according to an embodiment of the present disclosure;

FIG. 5 illustrates defined build areas for independent objects to be printed by a three-dimensional printer, according to an embodiment of the present disclosure;

FIG. 6 illustrates an embodiment of a method of printing multiple independent objects with a three-dimensional printer and, in particular, an aspect of a process of printing successive layers of traces with at least two print heads, according to an embodiment of the present disclosure; and

FIG. 7 illustrates an embodiment of a method of printing multiple independent objects with a three-dimensional printer and, in particular, an aspect of auto response when one print head has completed printing, according to an embodiment of the present disclosure.

### DETAILED DESCRIPTION

The present disclosure is directed to a printer, a method, and a controller for executing a method of printing multiple independent objects exhibiting different geometries simultaneously with a three-dimensional printer. In aspects, the independent geometries assume different form factors and shapes, including different heights. In simultaneously printing the objects, at least a portion of the independent objects are printed at the same time or concurrently.

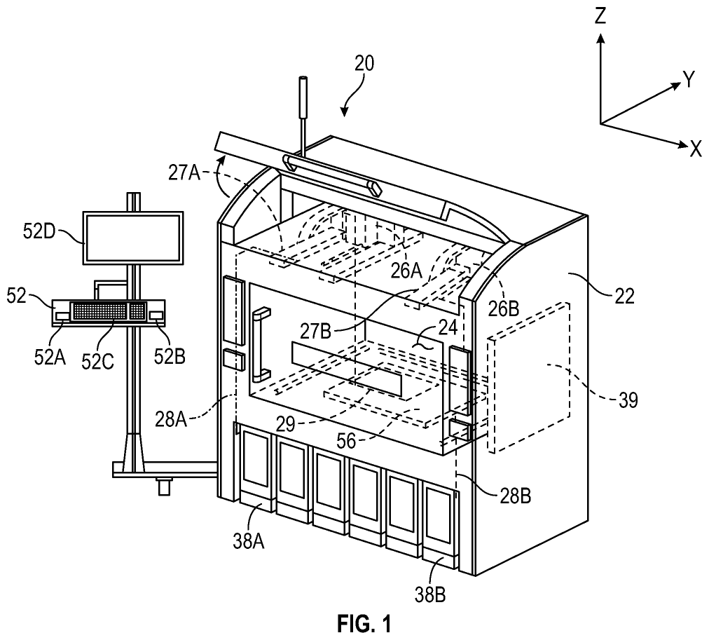

FIG. 1 illustrates an aspect of a three-dimensional printer 20. The printer includes a housing 22 that encloses a build chamber 24. Within the build chamber is positioned at least two print heads 26A, 26B, which are mounted on gantries 27A, 27B allowing independent movement of the print heads 26A, 26B in a plane defined by a first axis A1 and a second axis A2, often referred to as the x-axis and y-axis, respectively. The print heads 26A, 26B each include a nozzle that deposit traces 29 of filament 28A, 28B, spooled in filament carts 38 A, 38B, in successive layers on a print bed 56, which moves up and down on a third gantry 39 relative to the print heads 26A, 26B in along a third axis A3, commonly referred to as the z-axis. The movement of the print heads 26A, 26B and the print bed 56 are controlled by a controller 52 that includes one or more processors 52A that executes instructions provided to the controller 52. The instructions, and other data, is stored in memory 52B located within the controller 52. The controller 52 further includes input and output modules. Examples of input modules 52C include keyboards, trackpads, mice, USB ports, SD card ports, radio frequency receivers, etc. Examples of output modules 52D include display screens, USB ports, SD card ports, radio frequency transmitters, etc.

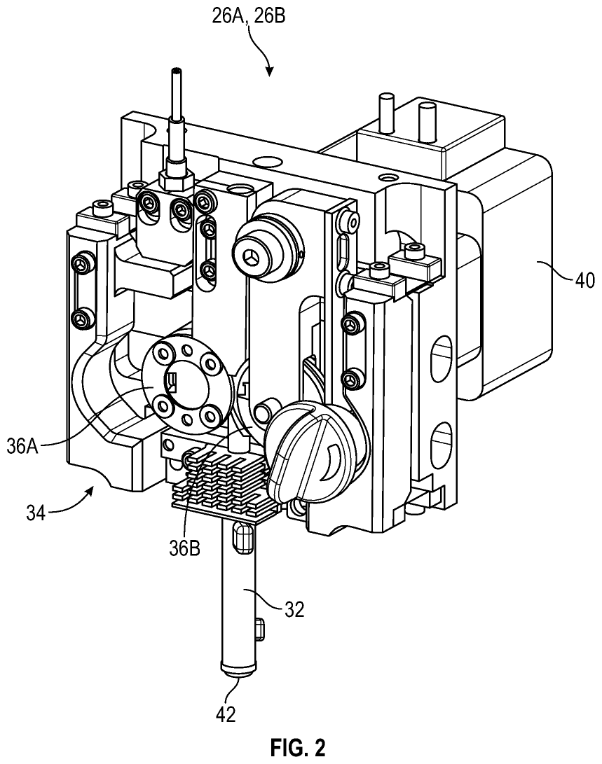

FIG. 2 illustrates an aspect of a print head 26 A, 26B. The print head 26 A, 26B includes a heated nozzle 32 for melting filament 28A, 28B received in the nozzle 32. The print head 26A, 26B further includes a drive system 34 for feeding the filament 28A, 28B into the nozzle 32. In the illustrated aspect, the drive system 34 includes drive hobs 36A, 36B and a motor 40 for rotating the drive hobs 36 A, 36B.

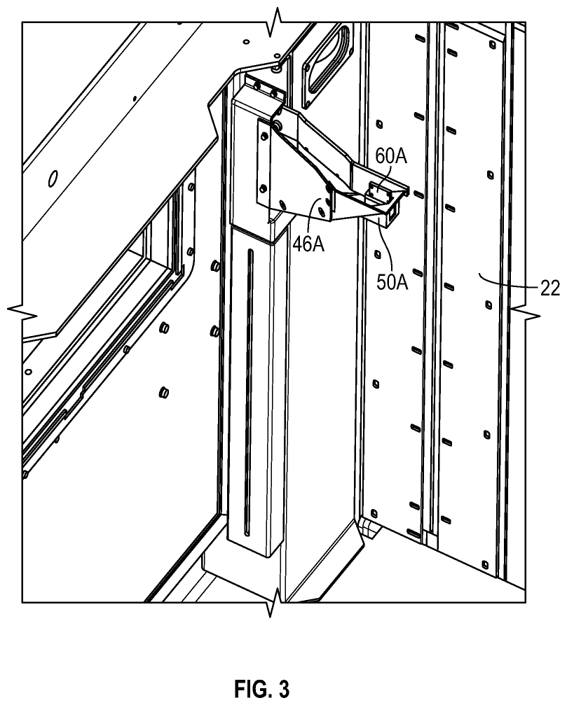

FIG. 3 illustrates an aspect of a wiper 50A for wiping a tip 42 (see FIG. 2) of the nozzle 32 after extruding filament 28A, 28B form the nozzle 32 to keep the nozzle 32 clean from excess extrudate, i.e., melted filament 28A, 28B. The wiper 50A includes, for example, a number of bristles 60A. The wiper 50A is mounted to an interior surface of the housing 22 is provided. In the illustrated aspect, an arm 46A to space the wiper 50A from the interior surface of the housing 22. In aspects, a wiper 50A is provided for every print head 26A, 26B and nozzle 32 in the printer 20. When not in use, the nozzle 32 may be parked proximal to the wiper 50A and moves over the wiper 50A before beginning a new trace 29 of filament 28 A, 28B.

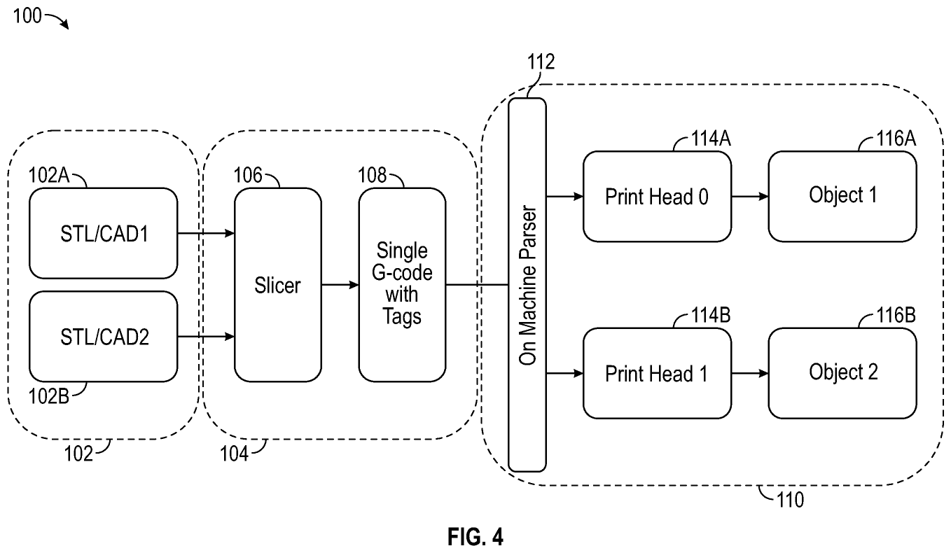

FIG. 4 illustrates an aspect of a method for printing multiple independent objects, each with an independent print head 26 A, 26B. The method 100 optionally begins at block 102 with the generation of computer aided design (CAD) file 102 A, 102B, such as an STL file, for each independent object to be printed by the three-dimensional printer 20. In aspects, the CAD files are generated using computer aided design software such as SOLIDWORKS. In further aspects, the executable code for the computer aided design software is provided in a computer independent from the printer, or alternatively is executed by the controller 52 located in the printer 20. Further, the CAD files 102A, 102B may be provided from a single source or from multiple sources, wherein the files are generated by multiple computers independent of, or associated with, the three-dimensional printer 20.

At block 104, the CAD files 102A, 102B are provided to a slicer 106, which is understood as executable instructions for the parsing of the CAD files 102 A, 102B into a plurality of layers, each layer representing a trace 29 of filament 28 A, 28B for deposition on the print bed 56. In addition to slicing the CAD files into printable layers, the slicer 106 also creates the printing path for each printable layer as well as instructions for heating the heated nozzle 32 and performing other functions in the printer 20 during printing. The slicer 106 then outputs these instructions as computer numerical control code, such as G-code 108.

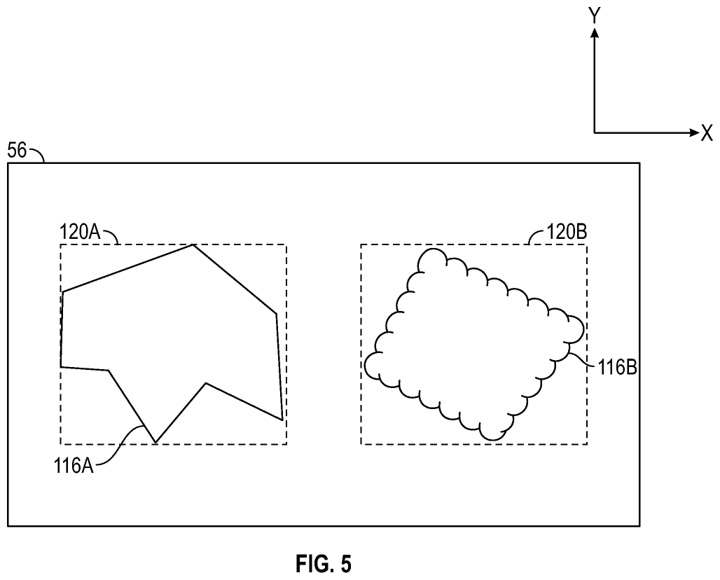

In aspects, the CAD files 102 A, 102B for each independent object are set as sequential print jobs in the g-code 108, wherein the slicer 106 creates instructions for the first object from the first CAD file 102 A and then creates instructions for the second object from the second CAD file 102B. Thus, a single g-code file 108 includes a first portion of instructions for printing the first independent object created from the first CAD file 102 A and a second portion of instructions for printing the second independent objected created from the second CAD file 102B. Without more, a printer would interpret and run the g-code to print in series, wherein the printer prints the first independent object with the first print head 26 A and, once complete, starts the second print job to print the second independent object with the second print head 26B. This arrangement avoids print head collisions by parking the print head that is not in use. However, in the present aspect and with reference to FIG. 5, the slicer 106 further defines the build area 120A, 120B of each object 116A, 116B in the X-Y plane to avoid head collision of the print heads 26 A, 26B. By defining the build area of each object in the X-Y plane, simultaneous printing of the independent objects may be completed by sufficiently spacing any given layer of both independent objects sufficiently far away from each other in the X-Y plane on the print bed 56 to prevent the print heads 26A, 26B from crashing. In addition, the slicer 106 is configured to label, i.e. tag, the g-code 108 to distinguish between the first CAD file 102A and the second CAD file 102B. Further, in aspects, the slicer 106 contains the proper print job preparation on the print head change scripts and initial scripts, such as providing instructions to the printer to perform specified actions before and after printing, such as z-probing the build area to determine where the print bed 56 is relative to the nozzle tip 42, heating the print bed 56 or the nozzle tip 42, parking the print head 26A, 26B, or wiping the nozzle 32 on each print head 26A, 26b. The resultant g-code 108 includes tags and scripts for all of the independent objects, in addition to M-code indicating independent objects may be simultaneously printed.

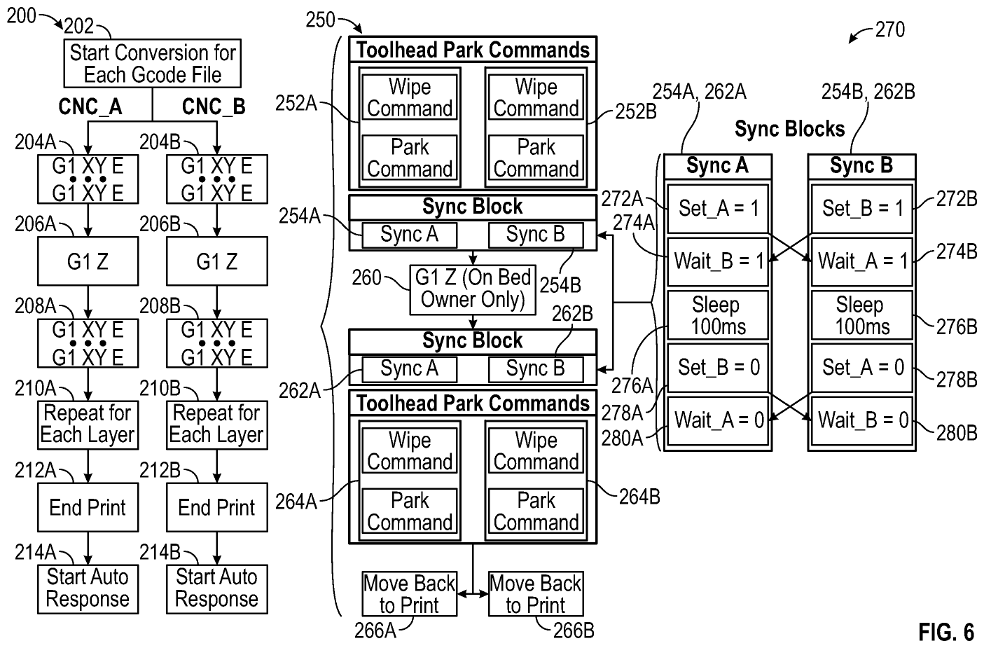

At block 110 the single g-code 108 file containing executable instructions for each independent object is provided to the three-dimensional printer 20 and is split into separate print jobs, outlined by each portion of the g-code 108, one for each print head 26A, 26B, correlating with each independent object CAD file 102 A, 102B. Once the user selects the g-code 108 with the slicer 106 on sequential mode, the machine parser 112 checks if the file contains the M-code indicating the g-code 108 represents instructions for simultaneously printing multiple independent objects. If the M-code does indicate the g-code 108 represents instructions for simultaneously printing multiple independent objects, the on-machine parser 112 includes executable instructions, executed by one or more processors associated with the printer 20, to create a print file 114A, 114B for each independent object, splitting the g-code 108 received by the printer 20 using tags or other methods. The on-machine parser 112 further includes instructions to insert the initial and ending script for each print head 26A, 26B. Further, the on-machine parser 112 will determine which print head 26A, 26B is printing the tallest part and mark the print head 26A, 26B printing the tallest part as bed owner. Translations in the z-direction will occurs at the behest of the print head 26A, 26B designated as the bed owner. Further, at block 110, and in executable instructions executed by the on-machine parser 112, synchronization blocks are added to the g-code 108, which is discussed further below with reference to FIGS. 5 and 6. Then each independent object is simultaneously printed by the print heads 26A, 26B. It is noted that the independent objects may begin printing at the same time, or end printing at the same time, or both begin and end at the same time provided the objects are the same height. Further, the printing, or at least a portion of the printing, of each independent object 116A, 116B by each print head 26 A, 26B occurs at the same time. That is, layers of the first independent object are printed by the printer 20 at the same time layers of the second independent object are printed.

With reference to FIG. 6, which illustrates a method 200 of a conversion process for independent print head 26 A, 26B movement, once the on-machine parser 112 flags that the g-code 108 includes multiple portions of the g-code 108 for simultaneously printing independent objects, the executable code at block 202 will instruct the onboard machine processor 122 to begin a print job CNC_A and CNC_B for the first print head 26A and the second print head 26B, respectively. After the g-code segment for printing a given layer (GIXY E . . . GIXY E) at bock 204 A, 204B, the process of conversion will replace each bed motion in the third axis A3 (G1 Z F) at block 206A, 206B on each print job with a synchronization sequence 250. The synchronization sequence 250 includes: a wipe command and parking command at block 252A for the print head 26A, 26B that finishes the layer first plus a synchronization waiting sequence at block 254A; a parking command and tool wiping command for the at block 252B for the print head 26A, 26B that finishes the layer later plus a Synchronization waiting sequence (block) 254B; the original bed motion command at block 260 for the print head 26A, 26B tagged as bed owner plus a synchronization block 262A; a synchronization sequence 262B at block 262B with no bed motion for the print head 26A, 26B that is not bed owner; a parking and wipe command at block 264 A, 264B for both print heads 26 A, 26B; and a return to print for both print heads 26 A, 26B at block 266 A, 266B. As an additional feature the parking commands could be omitted for the print heads 26A, 26B that finishes the layer latest if the controller 52, 112 that processes the print head 26A, 26B job supports conditional commands. The sync blocks 254A, 254B, 262A, 262B reference a sync block sequence 270.

The sync block sequence 270 for the print heads 26A, 26B include two handshakes. When each print job for the independent components finish, at blocks 272A, 272Ba flag is set in the on-board machine parser 112, or in another processor present in the printer 20. When the individual flags are set for each print head 26A, 26B, the parser 112 references the flags for the other print head 26A, 26B, to see if the flags have been set at block 274A, 274B. Once both flags are set, at block 276A, 276B, the parser waits for a period of time, in the illustrated example 100 ms; however, it may be any time period in the range of a few milliseconds to a few hundred milliseconds, including all values and ranges therein. At blocks 278A, 278B, the flags are reset for each print head 26A, 26B and then the flags for each print head are checked at 280 A, 280B. When both flags are reset, the bed translation GIZ command at block 260 is executed by the print head 26A, 26B that is noted as the bed owner and the program continues to print the next layer at blocks 208A, 208B and repeats again at each layer at blocks 210A, 210B until the print jobs have ended at blocks 212A, 212B.

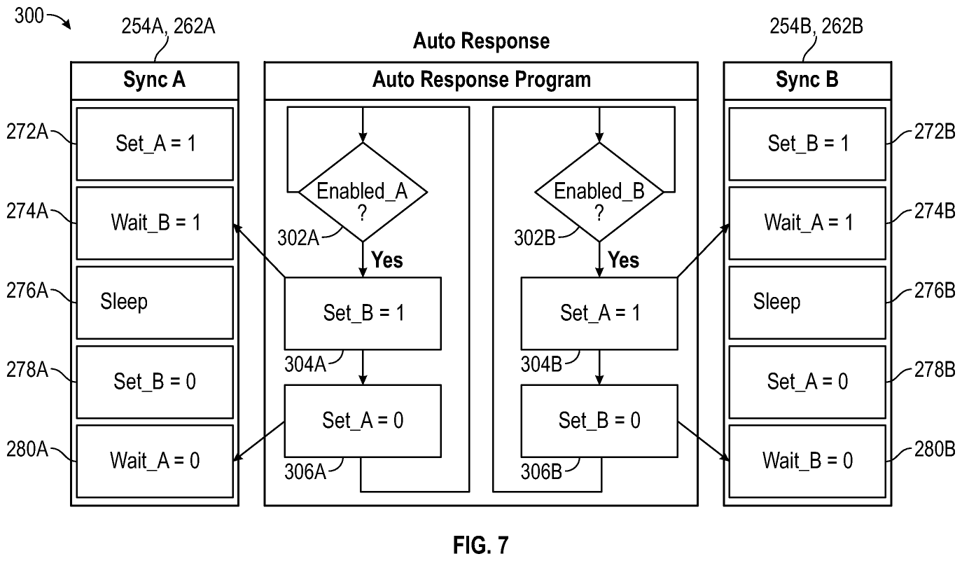

At blocks 214A, 214B, when printing of the first independent object is complete, but the second independent object has not been completed the programs start an autoresponse routine 300 as described in FIG. 7. This routine 300 replaces the synchronization sequences of for the print head 26A, 26B and print job that finishes first, as once the print job is complete, the program for that print job is no longer running. In the auto response program, the sync process 270 for the print head 26A, 26B that is still printing continues to run. However, when the print head 26A, 26B that is no longer running ends its run, it enables the auto response program at blocks 302 A, 302B. The auto response routine 300 supplies the handshakes for the print head 26A, 26B that has completed its print job. For example, if the auto response program is enabled for the first print head 26A at block 302A or the second print head 26B at block 302B then a flag is set for the print head 26A, 26B that has completed its print job at blocks 304A, 304B and when the flag is referenced by the running print head 26A, 26B at blocks 274A, 274B, the running print head proceeds to the next step of waiting a given timer period at blocks 276A, 276B. Again, while 100 ms illustrated, the time period may range from a few milliseconds to a few hundred milliseconds including all values and ranges therein. Then in proceeding to reset the flags at blocks 278A, 278B, the auto response program resets the flag at step 306A, 306B for the print head that is no longer running and the print head that is running references the flag at step 280 A, 280B. Once both flags are reset, the program continues to run until the print job of the bed owner is complete.

While the above method is described generally with reference to two print heads, it should be appreciated that the methods may be executed for more than two print heads and up to n-number of print heads.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. It is anticipated and intended that future developments will occur in the arts discussed herein, and that the disclosed systems and methods will be incorporated into such future implementations. In sum, it should be understood that the invention is capable of modification and variation.

1. A method of printing at least two independent objects, comprising:
providing a first CAD file and a second CAD file to a slicer, wherein the first CAD file represents a first object and the second CAD file represents a second object;
slicing the first CAD file into a first set of instructions for printing the first object and slicing the second CAD file into a second set of instructions for printing a second object, wherein slicing the first CAD file and the second CAD file includes parsing the first CAD file in a first plurality of layers and the second CAD file into a second plurality of layers and creating a first print path for the first plurality of layers and a second print path for the second plurality of layers;
defining a first build area for the first object and defining a second build area for the second object;
spacing apart the first build area from the second build area a distance in an X, Y-plane;
creating a g-code file including the first set of instructions for printing the first object and the second set of instructions for printing the second object, wherein the second object is spaced apart the distance in the X, Y-plane from the first object in the g-code file;
determining which of the first object and the second object is taller and setting one of the first print head and the second print head as a bed owner based on which of the first object and the second object is taller and executing the g-code file by a printer; and
printing the first object with a first print head on a print bed in the printer and the second object with a second print head on the print bed in the printer, wherein at least of a portion of the first object and the second object are printed simultaneously and the first object is spaced apart from the second object the distance in the X, Y-plane.

2. (canceled)

3. The method of claim 1, wherein the first set of instructions and the second set of instructions are set as sequential print jobs in the g-code file.

4. The method of claim 3, wherein the printer includes an on-board machine parser and executing the g-code file includes checking if the g-code file includes m-code indicating the g-code file includes the first set of instructions and the second set of instructions for simultaneously printing the first object and the second object.

5. The method of claim 3, further comprising splitting the first set of instructions for the first object from the second set of instructions for the second object while executing the g-code.

6. (canceled)

7. The method of claim 1, further comprising lowering the print bed based one of the first set of instructions and the second set of instructions that is associated with the bed owner.

8. A method of printing at least two independent objects, comprising:
providing a first CAD file and a second CAD file to a slicer, wherein the first CAD file represents a first object and the second CAD file represents a second object;
slicing the first CAD file into a first set of instructions for printing the first object and slicing the second CAD file into a second set of instructions for printing a second object, wherein slicing the first CAD file and the second CAD file includes parsing the first CAD file in a first plurality of layers and the second CAD file into a second plurality of layers and creating a first print path for the first plurality of layers and a second print path for the second plurality of layers, and the first set of instructions include a motion in a z-axis after printing at least one layer of a first plurality of layers and the second set of instructions include a motion in the z-axis after printing at least one layer of a second plurality of layers and the method further comprises replacing the motions with a synchronization sequence;
defining a first build area for the first object and defining a second build area for the second object;
spacing apart the first build area from the second build area a distance in an X, Y-plane;
creating a g-code file including the first set of instructions for printing the first object and the second set of instructions for printing the second object, wherein the second object is spaced apart the distance in the X, Y-plane from the first object in the g-code file;
executing the g-code file by a printer; and
printing the first object with a first print head on a print bed in the printer and the second object with a second print head on the print bed in the printer, wherein at least of a portion of the first object and the second object are printed simultaneously and the first object is spaced apart from the second object the distance in the X, Y-plane.

9. The method of claim 8, wherein the synchronization sequence includes wiping and parking one of the first print head and the second print head that finishes printing a given layer of both the first plurality of layers the second plurality of layers first.

10. The method of claim 9, wherein the synchronization sequence further includes setting a first flag when the first print head is finished printing the given layer and setting a second flag when the second print head is finished printing the given layer; resetting the first flag and the second flag after both the first flag and the second flag are set; checking both the first flag and the second flag have been reset; and executing a lower print bed command for the one of the first print head and the second print head set as a bed owner.

11. The method of claim 8, further comprising running an auto-response routine for the print head that finishes printing first of the first print head and the second print head.

12. The method of claim 1, further comprising setting the distance sufficient to prevent the first print head and the second print head from colliding while the first print head prints the first object and the second print head prints the second object.

13. A printer for printing at least two independent objects, comprising:
a controller;
a print bed connected to the controller;
a first print head for printing a first object on the print bed connected to the controller;
a second print head for printing a second object on the print bed connected to the controller; and
an on-board machine parser connected to the controller;
wherein the controller is configured to execute instructions to:
parse a g-code file including a first set of instructions for printing a first object and a second set of instructions for printing a second object,
determine which of the first object and the second object is taller and setting one of the first print head and the second print head as a bed owner based on which of the first object and the second object is taller, and
print the first object with the first print head and print the second object with the second print head on the print bed in the printer, wherein at least of a portion of the first object and the second object are printed simultaneously and the first object is spaced apart from the second object a distance in an X, Y-plane.

14. The printer of claim 13, wherein the controller is further configured to execute instructions to check if the g-code file includes m-code indicating the g-code file includes the first set of instructions and the second set of instructions for simultaneously printing the first object and the second object.

15. The printer of claim 13, wherein the controller is further configured execute instructions to split the first set of instructions for the first object from the second set of instructions for the second object while executing the g-code.

16. (canceled)

17. The printer of claim 13, wherein the controller is further configured to execute instructions to lower the print bed in a z-axis based one of the first set of instructions and the second set of instructions that is associated with the bed owner.

18. The printer of claim 17, wherein the first set of instructions include a first motion in a z-axis after printing at least one layer of a first plurality of layers and the second set of instructions include a second motion in the z-axis after printing at least one layer of a second plurality of layers and wherein the controller is further configured to execute instructions to replace the first motion and the second motion in the z-axis with a synchronization sequence.

19. The printer of claim 18, wherein during the synchronization sequence the controller if further configured to execute instructions to wipe and park one of the first print head and the second print head that finishes printing a given layer of both the first plurality of layers the second plurality of layers first.

20. The printer of claim 19, wherein the synchronization sequence further includes setting a first flag when the first print head is finished printing the given layer and setting a second flag when the second print head is finished printing the given layer; resetting the first flag and the second flag after both the first flag and the second flag are set; checking both the first flag and the second flag have been reset; and executing a lower print bed command for the one of the first print head and the second print head set as a bed owner.
